(19) United States
(12) Patent Application Publication
(10) Pub. No.: US 2007/0232402 A1
(43) Pub. Date: Oct. 4, 2007

(54) Precision friction clutch module

(75) Inventor: Ying-Chou Cheng, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur Morges (CH)

(21) Appl. No.: 11/397,272

(22) Filed: Apr. 3, 2006

(51) Int. Cl. F16D 7/02

(52) U.S. Cl. 464/40

(57) ABSTRACT

A clutch includes a hub having a hub flange formed at a first end. The clutch further includes a clutch tube having a central aperture formed therein, a clutch tube flange, and a friction surface that is substantially planar. The central aperture is configured to receive the shaft and is substantially perpendicular to the friction surface. The clutch further includes a clutch plate having a clutch surface that is substantially planar and is in contact with the friction surface. The clutch further includes a fastener configured to couple the clutch plate to the hub; and a spring device configured to push the hub flange and the clutch tube flange away from one another and push the friction surface to contact the clutch surface.

### BACKGROUND OF THE INVENTION

The present invention relates to a clutch device useful for protecting delicate devices that are coupled by the clutch device. More particularly, the present invention relates to a clutch device configured to provide controlled slip for limiting forces and impulses that may be transferred between devices the clutch device couples.

Traditional clutch devices are configured to engage and disengage to provide a mechanical connection between devices and for the transfer of motion between the devices. In an engaged configuration, traditional clutch devices typically provide mechanical transfer of motion between devices that the clutch device couples. These traditional clutch devices often are configured to transfer rotation motion between rotatable devices, such as a motor and a shaft. In a disengaged position, a first device coupled to the clutch is permitted to continue its motion, e.g., rotational motion of a motor, while another device, e.g., a shaft, will not receive transferred motion from the first device.

New clutch devices are needed that engage for smooth rotation and are configured to slip if an impulse is applied to one or more of the devices the clutch device couples.

### BRIEF SUMMARY OF THE INVENTION

The present invention provides a clutch configured to rotationally link devices and to provide controlled slip for limiting forces and impulses that may be transferred between the devices the clutch couples. Limiting the forces and/or impulses transferred between devices coupled by the clutch inhibits the damage that may be caused to one or both of the devices if one of the devices is physically jarred.

According to one embodiment, the clutch includes a hub having a hub flange formed at a first end. The clutch device also includes a clutch tube having a central aperture formed therein, a clutch tube flange, and a friction surface that is substantially planar. The central aperture is configured to receive the shaft and is substantially perpendicular to the friction surface. The clutch device also includes a clutch plate having a clutch surface that is substantially planar and in contact with the friction surface. A fastener is configured to couple the clutch plate to the hub. A spring device is configured to push the hub flange and the clutch tube flange away from one another and push the friction surface to contact the clutch surface.

A spindle shaft is formed in the first end of the hub and is configured to receive a spindle configured to rotate the clutch device. The spindle shaft has a first shape and the spindle has a second shape that is complimentary to the first shape. The spindle may be a motor spindle. A shaft is formed in the second end of the hub and is configured to receive the fastener. The clutch plate includes a central aperture formed therein and the fastener is positioned through the central aperture to couple the clutch plate to the hub.

According to a specific embodiment, the clutch further includes a clutch support configured to couple to the clutch plate. The clutch support is configured to support the clutch plate if the clutch is hit. The clutch support and the clutch plate may be sliding contact.

The hub is configured to be rotated and is configured to transfer rotational motion to the clutch tube and the clutch plate. The friction surface and clutch surface are configured to rotate relative to each other (i.e., slip past each other) if the clutch tub is acted on with a force greater than a threshold force or with an impulse greater than a threshold impulse. The relative rotation of these clutch elements provides a cushioning effect between devices that are coupled by the clutch, if one of the devices is physically hit or knocked.

A better understanding of the nature and advantages of the present invention may be gained with reference to the following detailed description and the accompanying drawings.

### BRIEF DESCRIPTION OF THE DRAWINGS

FIG. 1 is an overall perspective view of a clutch device according to one embodiment of the present invention;

FIG. 2 is a cross-sectional view of the clutch device;

FIG. 3 shows a motor and arm coupled by the clutch device according to a specific embodiment of the present invention; and

FIG. 4 is a simplified schematic of the motor configured to rotate the clutch device and arm into a housing.

### DETAILED DESCRIPTION OF THE INVENTION

The present invention provides a clutch device useful for protecting delicate devices coupled thereto. More specifically, the present invention provides a clutch device that is configured to provide controlled slip for limiting the forces and impulses transferred between devices that are coupled by the clutch device.

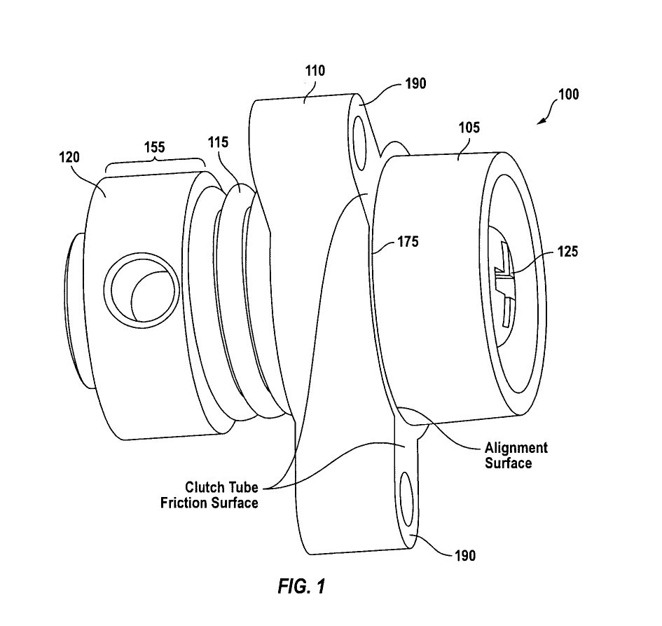

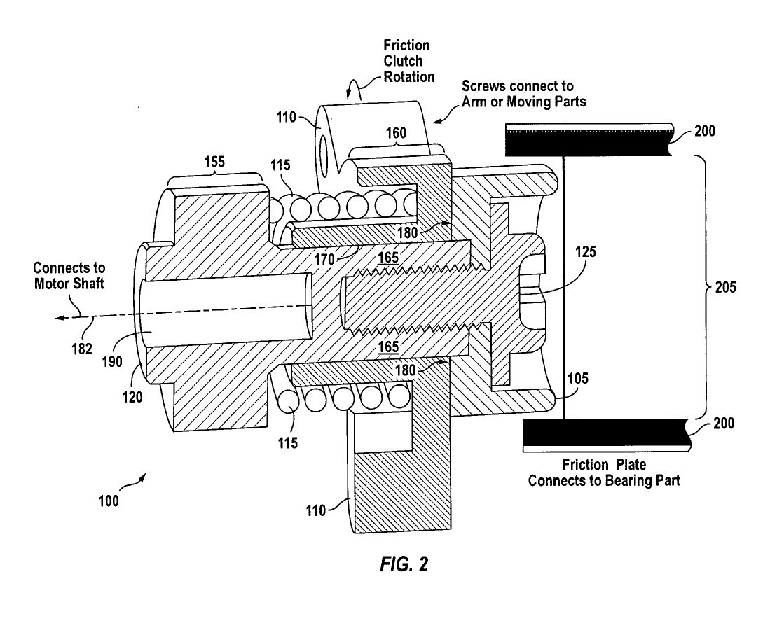

FIGS. 1 and 2 are an overall perspective view and a cross-sectional view of a clutch device 100 according to an embodiment of the present invention. Clutch device 100 includes a clutch plate 105, a clutch tube 110, a spring device 115, a hub 120, and a fastener 125.

Hub 120 may be coupled to clutch plate 150 via fastener 125, which may be a screw that is configured to be threaded into the hub. The hub and the clutch tube include flanges 155 and 160, respectively, that are configured to compress the spring under the force of the screw pulling a central shaft 165 of the hub into an aperture 170 formed in the clutch tube. The outer surface of central shaft 165 and the inner surface of aperture 170 may be bearing surfaces that permit the hub and clutch tube to rotate relative one another as described below.

Clutch tube 110 includes a friction surface 175 that is configured to contact a clutch surface 180 of clutch plate 105. Friction surface 175 and clutch surface 180 may be substantially planar and substantially parallel. The friction surface and the clutch surface may be substantially perpendicular to a central axis 182 of the clutch device about which the clutch device is configured to be rotated (described in further detail below). Under the force of the fastener applied to the hub and clutch plate, the spring is configured to press the friction surface into clutch contact with the clutch surface. Clutch contact includes contact that may transition from static friction to kinetic friction and/or from kinetic friction to static friction under predetermined forces. The predetermined forces may be set based on the particular spring included in the clutch device, wherein various springs may effect various predetermined forces.

According to one embodiment, the hub is configured to be rotated, for example, by a motor or the like, and transfer it rotation to the clutch tube and the clutch plate. As friction surface 175 and clutch surface 180 may be substantially planar and parallel, these surfaces are configured to hold the clutch tube's central axis substantially aligned with the central axes of the hub and the clutch plate, for example, as the clutch device is rotated. The central axes of the clutch tube, the hub, and the clutch plate are configured to substantially align with central axis 182 of the clutch device. As the hub is rotated, if a force above a threshold force or an impulse above a threshold impulse is applied to the clutch tube, the clutch tube will stop rotating. That is, the friction between the friction surface and the clutch surface will transition from static friction to kinetic friction, and the hub and clutch plate will continue to rotate as the clutch tube is stopped by the force or impulse. Alternatively stated, the friction surface and the clutch surface will slip past one another under the applied force. Alternatively, the clutch device may not be rotated, but the clutch tube, the hub, and/or the clutch plate may have a force or impulse applied thereto that is higher than a threshold force or a threshold impulse. Under the applied force or impulse, the clutch tube may be configured to rotate relative to the hub and the clutch plate. That is, the friction surface and clutch surface will slip relative to each other.

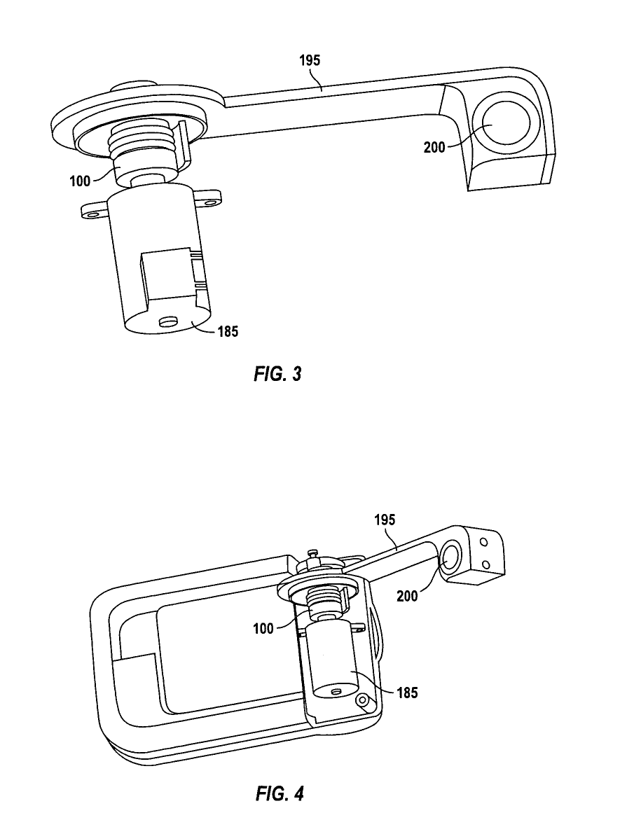

FIG. 3 shows a motor 182 coupled to clutch device 100 according to a specific embodiment of the present invention. The hub may include a spindle shaft 190 (see FIG. 2) formed therein that is configure to receive a spindle (not shown) of motor 170 or the like. The spindle and spindle shaft may be keyed (i.e., have complimentary shapes) so that the motor may rotate the clutch device. The motor may be a stepper motor and/or may include a gear box for gearing the rotation of the spindle and clutch device. It should be understood that a motor is one exemplary device that may be coupled to the clutch device to effect rotation thereof. Those of skill in the art will know of other devices that may be coupled to the clutch device to effect rotation of the clutch device.

The clutch tube may include a set of tabs 190 that may be threaded. The tabs may couple an arm 195 (see FIG. 3) or the like to the clutch device. According to a specific embodiment, arm 195 may be configured to hold a camera, such as a web cam 200. The motor may be configured to rotate the clutch device and arm into and out of a housing 205 (see FIG. 4). While the tabs are described as being coupled to arm 180 according to a specific embodiment of the invention, the threaded tabs may be coupled to nearly any device configured to be rotated. Accordingly, it should be understood that the foregoing described embodiment is exemplary.

According to one embodiment, if arm 195 or the like is jarred by a force or an impulse that is above the threshold force or the threshold impulse, the clutch tube and the arm are configured to rotate relative to the clutch plate, the hub, and the motor. More specifically, if the force or impulse on the arm is above the threshold force or the threshold impulse, the friction surface and the clutch surface will rotationally slip relative to each other as the friction between these surfaces transitions from static friction to kinetic friction. Due to this slip, the arm and motor will permitted to rotate relative to one anther. As the clutch is configured to slip to permit the attached devices to rotate relative to one another under a select force or a select impulse, the attached devices may be prevented from causing damage to one another. For example, if arm 180 is jarred (e.g., dropped, bumped, knocked over, etc.) by a force or an impulse that is above the threshold force or the threshold impulse, then the motor and its attached gear box, for example, may be inhibited from being damaged by limiting the amount of force or impulse that reaches the motor and its gear box from the arm. The limited force and/or limited impulse that is transferred trough the clutch will substantially be the threshold force and/or the threshold impulse.

The amount of force or impulse that causes the friction plate and clutch plate to transition from static friction to kinetic friction may be tuned based the particular spring included in the clutch device. That is, the spring may be changed to permit tuning of the threshold force or the threshold impulse. Tuning the threshold force and/or the threshold impulse permits a user of the device to set the amount of force and/or impulse that may be transferred between devices (e.g., motor and arm) coupled by the clutch device. Such tuning, in turn, permits the user to inhibit, to the degree desired, the damage caused from the transfer of forces and/or impulses between devices coupled by the clutch device.

According to one embodiment, the clutch device includes a clutch support 200 (see FIG. 2) that is configured to support the clutch plate. Clutch support 200 may have a central opening 205 formed therein that is configured to receive the clutch plate. While the clutch support is shown in FIG. 2 as being disposed around the outer surface of the clutch plate, the clutch support may be configured to support the clutch plate from an inner surface thereof. The clutch support might be configured to be in sliding contact with the clutch plate. The clutch support may be substantially rigidly supported independently from the other elements of the clutch device. As such, if the clutch device or the various devices (e.g., arm, motor, video camera, etc.) coupled by the clutch device are jarred by a force or an impulse, the clutch device may be inhibited from being moved (e.g., tilted) by the clutch support. Inhibiting the tilt, for example, of the clutch device under a force or an impulse provides that the clutch device and the various elements coupled to the clutch device may not be damaged from the force or impulse. For example, the spindle of the motor may be inhibited from being bent from the force or impulse.

It is to be understood that the examples and embodiments described above are for illustrative purposes only and that various modifications or changes in light thereof will be suggested to persons skilled in the art and are to be included within the spirit and purview of this application and scope of the appended claims. For example, while the hub is described as including a spindle shaft formed therein for receiving a spindle of the motor, an outer surface of the hub may be configured to couple to the motor. The outer surface of the hub may bed keyed via a substantially flat portion and/or may include a hole formed therein for receiving a fastener or the like for coupling the motor to the hub. Further, while an exemplary use of the clutch device has been described for coupling a motor and an arm that is configured to hold a camera, it should be understood that the clutch device may be configured to couple a variety of devices as will be understood by those of skill in the art. Therefore, the above description should not be understood as limiting the scope of the invention as defined by the claims.

What is claimed is:

1. A clutch device comprising:
a hub having a hub flange formed at a first end;
a clutch tube having a central aperture formed therein, a clutch tube flange, and a friction surface that is substantially planar, wherein the central aperture is configured to receive the shaft and is substantially perpendicular to the friction surface;
a clutch plate having a clutch surface that is substantially planar and in contact with the friction surface;
a fastener configured to couple the clutch plate to the hub; and
a spring device configured to push the hub flange and the clutch tube flange away from one another and push the friction surface to contact the clutch surface.

2. The clutch device of claim 1, wherein a spindle shaft is formed in the first end of the hub and is configured to receive a spindle configured to rotate the clutch device.

3. The clutch device of claim 2, wherein the spindle shaft has a first shape and the spindle has a second shape that is complimentary to the first shape.

4. The clutch device of claim 3, wherein the spindle is a motor spindle.

5. The clutch device of claim 1, wherein a shaft is formed in the second end and is configured to receive the fastener.

6. The clutch device of claim 5, wherein the shaft is a threaded shaft.

7. The clutch device of claim 6, wherein the clutch plate includes a central aperture formed therein and the fastener is positioned through the central aperture to couple the clutch plate to the hub.

8. The clutch device of claim 1, wherein the clutch tube includes a set of tabs configured to couple to a device that is configured to be rotated by the clutch device.

9. The clutch device of claim 1, further comprising a clutch support configured to couple to the clutch plate.

10. The clutch device of claim 9, wherein the clutch support is configured to support the clutch plate if the clutch is hit.

11. The clutch device of claim 10, wherein the clutch support and the clutch plate are in sliding contact.

12. The clutch device of claim 1, wherein:
the hub is configured to be rotated and is configured to transfer rotational motion to the clutch tube and the clutch plate, and
the friction surface and clutch surface are configured to rotate relative to each other if the clutch tub is acted on with a force greater than a threshold force or with an impulse greater than a threshold impulse.

13. The clutch device of claim 1, wherein a surface of the shaft is configured to be in sliding contact with a surface of the central aperture.

14. A clutch device comprising:
a hub configured to be rotated;
a clutch plate coupled to the hub and having a clutch surface;
a clutch tube having a friction surface; and
a spring device configured to push the friction surface into clutch contact the clutch surface,
the hub is configured to transfer rotational motion to the clutch tube and the clutch plate, and
the friction surface and clutch surface are configured to rotate relative to each other if the clutch tub is acted on with a force greater than a threshold force or with an impulse greater than a threshold impulse.

15. The clutch device of claim 14, wherein the hub includes a shaft having an outer surface that is configured to be in sliding contact with a surface of a central aperture formed in the clutch tube.

16. The clutch device of claim 14, further including a fastener configured to couple the clutch plate to the hub.
